(19) United States
(12) Patent Application Publication
(10) Pub. No.: US 2026/0296754 A1
(43) Pub. Date: Oct. 1, 2026

(54) STAND-UP FILM POUCHES AND METHOD FOR PRODUCING A STAND-UP FILM POUCH

(71) Applicant: Mondi AG, Wien (AU)

(72) Inventor: Jens KÖSTERS, Wallenhorst (DE)

(21) Appl. No.: 19/456,582

(22) Filed: Jan. 22, 2026

(30) Foreign Application Priority Data
Mar. 26, 2025 (DE) 10 2025 111 641.5

(51) Int. Cl. B65D 75/00; B65D 75/56; B65D 75/58

(52) U.S. Cl. CPC B65D 75/008; B65D 75/566; B65D 75/5883

(57) ABSTRACT

A stand-up film pouch comprising a pouch body, wherein the pouch body has two front walls that are situated opposite each other and connected to each other at the longitudinal edges thereof, and a film section that is arranged between the front walls on an underside of the pouch to form a stand-up bottom. At least one of the front walls in an upper wall section has a material molding that deviates from a flat shape. A method for producing a stand-up film pouch is also disclosed.

### CROSS-REFERENCE TO RELATED APPLICATIONS

Not applicable.

### FIELD OF THE INVENTION

The invention relates to a stand-up film pouch comprising a pouch body, wherein the pouch body has two front walls that are situated opposite each other and connected to each other at the longitudinal edges thereof, and a film section that is arranged between the front walls at an underside of the pouch to form a stand-up bottom. The invention also relates to a method for producing a corresponding stand-up film pouch.

### BACKGROUND OF THE INVENTION

Stand-up film pouches, also referred to as stand-up pouches (SUP), are known in various designs from practice experience. The pouch body is sealed when filled and thus forms a film package.

Stand-up film pouches are suitable for various materials to be added such as food, pet food, cosmetic products, household chemicals, or the like.

Stand-up film pouches are also frequently used for liquid, including pasty or generally free-flowing materials to be added. The pouch body can also comprise a spout or the like at the upper pouch edge thereof. The stand-up film pouch can then be used, for example, for beverages, liquid household chemicals such as laundry detergents and cleaning agents, cosmetic products such as liquid soap, or the like.

Stand-up film pouches of the type in question are known from EP 3 168 169 B1, EP 3 594 144 B1, and EP 3 889 060 B1.

In stand-up film pouches of the type in question, the front walls of the pouch body are directly connected to each other at the longitudinal edges and at least part of the upper pouch edge. In a simple design, the two front walls are connected at the upper pouch edge by a continuous cross seal, seam which can also be formed after filling so as to seal the pouch body.

Alternatively, it is also possible to provide a reclosable closure, in particular in the form of a spout, at the upper pouch edge, for example in the center or in the region of a corner, wherein the front walls are then connected there accordingly by way of the spout. In the case of an arrangement at a corner, the front walls are then generally also connected at an upper section of the respective longitudinal edge by way of the spout.

Furthermore, it is known that handle moldings, holes, or the like can be formed in a sealed region at the upper edge of the pouch body by means of notches or punched-out sections.

So as to form the stand-up bottom, the film section is arranged on the pouch underside between the front walls so that the pouch body can also be spread accordingly far apart there. The front walls and the film section for the stand-up bottom can be formed either of separate film pre-cut parts or together from a single film web.

Regardless, however, the stand-up film pouch according to the state of the art has a specific shape. Proceeding from the stand-up bottom spread by the film section, the interior of the pouch body tapers upwardly. Viewed from the side, this results in a kind of triangular shape, which in a broader sense can also be referred to as conical.

Even though stand-up film pouches of the type in question are marked by excellent standing capability and an attractive appearance, the ratio of surface area to volume is not optimal due to the described triangular or conical shape.

Disadvantages also arise in terms of the storage and transport of stand-up film pouches of the type in question. Both are usually carried out with stand-up film pouches in an upright position, which can be placed in a cardboard box or on a suitable surface, for example. While stand-up film pouches can then be packed relatively tightly in the bottom region, the triangular or conical shape results in a large gap between the pouches at the top pouch edge. Due to this free space, the stand-up film pouches can only be packed tightly to a limited extent, so that additional transport volume is required, thereby increasing packaging and logistics costs, for example.

Such aspects also have a negative impact on the ecological balance, for example, the calculation of CO2 emissions.

In addition, efforts to reduce packaging materials as much as possible are known. Even if a highly recyclable material is used, reducing the amount of material in both production and recycling can result in efficiency benefits and, in general, also in cost benefits.

### SUMMARY OF THE INVENTION

It is therefore the object of the present invention to provide an improved stand-up film pouch and a method for the production thereof.

The subject matter of the invention and the solution to the problem are a stand-up film pouch and a method for producing a stand-up film pouch.

Proceeding from a stand-up film pouch of the type in question, it is therefore provided according to the invention that at least one of the front walls in an upper wall section has a material molding that deviates from a flat shape. The material molding increases the volume in the upper region of the pouch body at the corresponding front wall, while the dimensions of the corresponding front wall in the top view are to remain unchanged compared to a flat shape.

Compared to a known stand-up film pouch, at least one of the front walls in the upper region of the pouch body has a three-dimensional molded shape, forming a kind of bulge that protrudes outward and thus provides additional filling space. Even though the material molding is to be located on the upper wall section, the material molding can also extend across a larger area of the front wall. The region of the material molding, for example, does not have to be limited to the upper half of the front wall, even though a center of the material molding is usually located in the upper half of the respective front wall.

In contrast to known thermoformed packaging, which has, for example, a trough and a separate cover film, no three-dimensionally fully molded tray or the like is formed. Rather, the front walls, which are already provided and extend upwardly from the stand-up bottom, are deformed three-dimensionally to a certain degree so as to provide an improved pouch geometry having an increased filling volume.

According to a preferred embodiment of the invention, the front walls are directly connected to each other at the longitudinal edges and at least part of an upper pouch edge.

In a simple embodiment of the stand-up film pouch, the two front walls are connected at the upper edge of the pouch by a continuous cross seam. However, it is also possible to use spouts or similar elements, which are then inserted between the front walls, for example by heat sealing. In such an embodiment, the front walls are then connected locally by way of the spout or a comparable element. The spout can be located in the center or at another point on the upper pouch edge. In addition, it can also be arranged in the region of a pouch corner.

The material molding in at least one of the outer walls is selected so that the triangular or conical shape known from the prior art is enlarged. Such a material molding can be implemented for example, by thermoforming, wherein excessive weakening of the pouch body should be avoided at the same time.

Several aspects can be taken into account against this background. Initially, it is advantageous if the material molding in at least one of the front walls ends a distance apart from the longitudinal edges and/or a distance apart from the upper pouch edge. This ensures that the region of the front wall which has been thinned to a certain extent by the thermofoming process is not brought directly next to a longitudinal seam and/or cross seam typically formed by heat sealing. Such seams in particular are subjected to special forces when a filled stand-up film pouch experiences loading, so that further weakening should be avoided there. Firstly, there is a transition from the flexible sections of the front walls to a reinforced two-layer region at the edge of the sealed seam. In addition, the heat input during heat sealing can cause a certain weakening of the material, even if no impairments are visible in the region of the sealed seam. Finally, the sealing process can also result in material thinning due to the application of heat.

Depending on the size and design of the stand-up film pouch, the material molding can end a distance of, for example, 1 mm to 30 mm, in particular 2 mm to 10 mm, apart from the longitudinal edges and/or the upper edge or the sealed seams formed there.

In terms of the strength of the pouch body, it is also advantageous if there is no excessive thinning in the region of the material molding. For this purpose, the thickness of the front walls outside the material molding can be compared with a minimum thickness in the region of the material molding. The minimum thickness is usually at least 50% of the thickness outside the material molding. It should also be noted that, in principle, a comparatively slight and uniform deformation is sufficient to provide the corresponding front wall with a volume-increasing expansion in the form of a bulge.

Within the scope of the invention, it may be provided, for example, that the front walls outside the material molding have a thickness between 40 µm and 200 µm. In particular proceeding from this value range, it may be provided that a minimum thickness of the respective front wall in the region of the material molding is between 30 µm and 180 µm.

As was previously explained above, the pouch body, when being filled, is positioned in a relatively wide position as a result of the film section for forming the stand-up bottom. The material molding according to the invention, in contrast, is provided on an upper wall section so as to partially compensate for the described triangular or conical shape.

Against this background, it may be provided that the material molding extends over 30% to 70% of a base area of the assigned front wall. The base area refers to the dimensions of the respective front wall in a top view, with the three-dimensional enlargement due to the material molding not being calculated then. Accordingly, within the scope of the invention, the entire surface of the front wall provided with the material molding is larger than the previously defined base area.

Taking into account the described criteria, it becomes evident that, according to a preferred embodiment of the invention, the material molding having a bulge shape has a design that is comparatively soft and no abrupt transitions and changes in thickness.

In particular, it may be provided that the material molding is designed with a bulge shape having a deformation depth that increases from an edge to a center of the material molding. Such a shape can also be formed particularly uniformly during a thermoforming process. If necessary, it may also be useful to optimize a corresponding thermoforming mold so as to allow the front wall to slide or flow during deformation.

In general, various methods and tools can be considered for creating the material molding. The material molding can, for example, be formed mechanically using a kind rigid punch. In addition or as an alternative, deformation by means of vacuum is possible, in which the film is applied to a corresponding vacuum mold. Deformation by means of hydraulics, for example, a deformable membrane and a fixed mating mold, is also conceivable within the scope of the invention.

According to a preferred embodiment of the invention, it is provided that each of the two front walls has the described material molding, wherein in particular an identical or substantially identical design of the front walls is then advantageous, so that a symmetrical or substantially symmetrical design results when viewed from the side. Particularly within the scope of such a design, a comparatively large increase in the filling volume is possible.

In principle, however, it is also conceivable to provide only one of the front walls with the molding, resulting in an asymmetrical pouch. The increase in filling volume then essentially only occurs on the front wall which has the material molding.

In an asymmetrical design, for example, a back of the pouch body can have the material molding, while the front of the pouch body is then formed by a flat section of film. The front can then feature high-quality print, while certain deformations and distortions are then more acceptable on the back. However, the increase in filling volume is accordingly smaller if only one of the two front walls has the described material molding.

Even with an asymmetrical design of the pouch body, the favorable standing capability of the pouch body is usually preserved since even then the center of gravity remains securely above the widely positioned stand-up bottom.

According to a preferred embodiment of the invention, it is also provided that the pouch body including the front walls and the film section is formed from a single type of material. It is particularly preferred that the pouch body is made of a single type of polyolefin, in particular polyethylene or polypropylene.

In this context, “single type” shall in particular be understood to mean that the front walls, the film section, and in particular the entire pouch body are made of plastic of one polymer class, such as polyethylene or polypropylene. It should be noted that the front walls can be formed of a multilayer film, wherein the pouch body can also have comprises components, such as the spout described above. Such a further element is then also advantageously made of the same single type of material as the front walls.

If, according to the described preferred design, different layers of the front walls and/or further components are identically made of polyethylene or polypropylene, these materials may also be present in different densities, such as ULDPE, VLDPE, LDPE, LLDPE, MDPE, LLMDPE, and HDPE. In principle, the different density classes can also be collected and recycled together, wherein such a mixture naturally has material properties that differ from those of the different individual source plastics.

Against this background, the pouch body can also be made of a single type of material in the narrower sense, wherein materials from a relatively narrow density range are then provided. With regard to polyethylene in particular, it may be advantageous to distinguish between high-density polyethylene (HDPE) and low-density polyethylene (LDPE) since according to Annex 5 of the German Packaging Act of June 5, 2017 (German Federal Act on the Household Separate Collection of Waste Containing Recyclable Materials) this results in different abbreviations and nomenclature (HDPE No. 2 and LDPE No. 4).

The properties of the plastic film can be influenced not just by the selection of the raw materials and, if necessary, a multi-layer design, but also by the production, modification, and processing of the plastic film. For example, the plastic film can be monoaxially or biaxially oriented, which can also lead to improved mechanical properties and/or other sealing properties.

If the plastic film of the pouch body is designed as a mono-film, it can be made of a single polymer type or a blend.

According to a preferred embodiment of the invention, the plastic film for the front walls is a multi-layer film, whereby the mechanical properties, desired barrier properties, and heat-sealing properties can be further influenced. For example, an outer layer of a multi-layer film may be monoaxially or biaxially oriented to improve the mechanical properties, wherein this layer can then be combined with a sealing layer. A sealing layer can, for example, be designed without orientation, which generally makes it easier to fuse. In addition, polymer types having a comparatively low density (for example, ULDPE, VLDPE, LDPE, LLDPE) are also known, which fuse at low temperatures. It is then possible to specify a sealing window with regard to the temperatures to be set, at which the outer side remains unaffected when a heat seal seam is being formed on the inside.

As is also known from the prior art, the pouch body can be designed with a carrying handle, a finger hole, or the like. A carrying handle can, for example, be formed by a notch or a punch-out in a sealed region. Corresponding embodiment are known from both EP 3 168 169 B1 and EP 3 594 144 B1.

The invention also relates to a method for producing a film pouch, wherein a pouch body is formed from a film web or film sections, which has two front walls that are situated opposite each other and connected to each other at the longitudinal edges thereof and a film section that is arranged between the front walls at an underside of the pouch to form a stand-up bottom. According to the invention, it is provided that a material molding which deviates from a flat shape is formed on at least one of the front walls before the pouch body is formed or on both front walls after the pouch body has been formed, in particular by thermoforming.

It is readily possible to provide at least one front wall with the material molding before the pouch body is formed. It is advantageous to carry out such a deformation, for example by thermoforming, shortly before the actual production of the pouch body since the corresponding film web may be more difficult to handle in a three-dimensional design. However, it should be noted that the direction of the material molding relative to a flat state toward the top or toward the bottom is irrelevant. Depending on the transport and surface, the material molding can initially extend upwardly, regardless of whether this deformation is then arranged towards the inside or the outside of the pouch body during further processing.

In particular, the two deformations can also initially point in the same direction in the unfilled pouch and thus coincide, in particular in the case of a substantially identical or identical design. The reason is that, when the pouch is being filled, the material molding becomes flared, regardless of the direction of production thereof, so as to then provide the increased filling volume as described.

Against this background, it also becomes evident that the pouch body can initially be formed in the known manner, wherein both front walls can then be deformed together, in particular thermoformed, in the pouch body that was previously produced. Then as well, the material moldings will become flared in the opposite direction to the outside when the pouch is being filled.

Within the scope of the invention, it may be relevant that the material molding causes the film on the corresponding front wall to become three-dimensionally deformed. If the corresponding front wall is already printed in accordance with a customary embodiment of the invention, this may also lead to deformation or distortion of the print. However, such influences may be acceptable, especially in the case of a comparatively low degree of deformation.

In principle, however, it is also conceivable within the scope of the invention that the film web or at least a section of the film is provided with a locally distorted print before the material molding is created in such a way that the creation of the material molding reduces or eliminates the distortion of the print. The shifts caused by the creation of the material molding are then compensated for, in a sense, by an adjusted distortion of the print.

In principle, however, it is also conceivable to provide a decoration in the region of deformation, which conceals any possible distortion for a user. For example, ring-shaped structures that extend concentrically around or within the material molding are conceivable.

### BRIEF DESCRIPTION OF DRAWINGS

The invention will be described hereafter based on exemplary illustrations.

FIG. 1 shows a stand-up film pouch.

FIG. 2A shows a stand-up film pouch according to the prior art in a side view.

FIGS. 2B and 2C each show a stand-up film pouch according to the invention in a side view.

FIG. 3 shows a schematic representation of an unfilled stand-up film pouch according to the invention in a top view.

FIG. 4 shows an exemplary method for producing the stand-up film pouch.

### DETAILED DESCRIPTION OF THE INVENTION

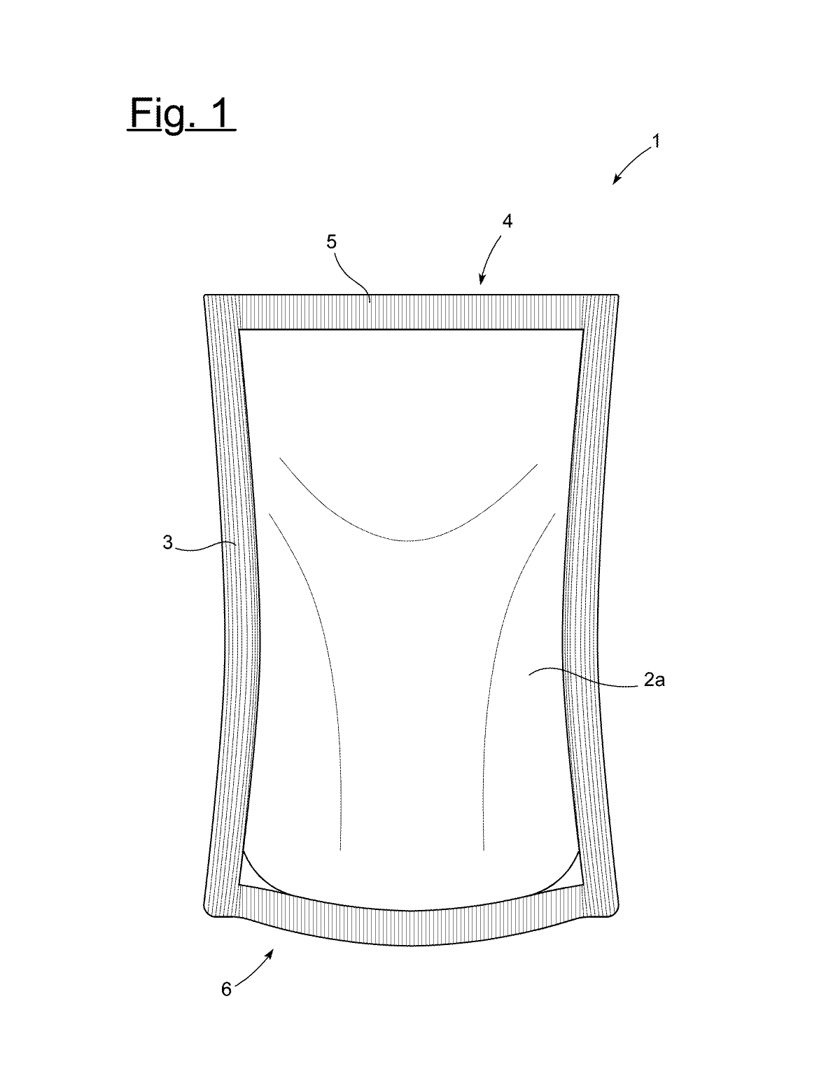

FIG. 1 shows a stand-up film pouch in a view from the front. The stand-up film pouch comprises a pouch body 1 having two front walls 2a, 2b situated opposite one another. The front walls 2a, 2b are directly connected at longitudinal seal seams 3 and at the upper pouch edge 4 by way of a cross seal seam 5. To create a stand-up bottom 6 that is also recognizable from the shape of the pouch body 1, a film section is provided, which is arranged between the front walls 2a, 2b. FIG. 1 shows approximately a front view of the stand-up film pouch in a filled state, wherein in this view the special features of the present invention are not readily apparent.

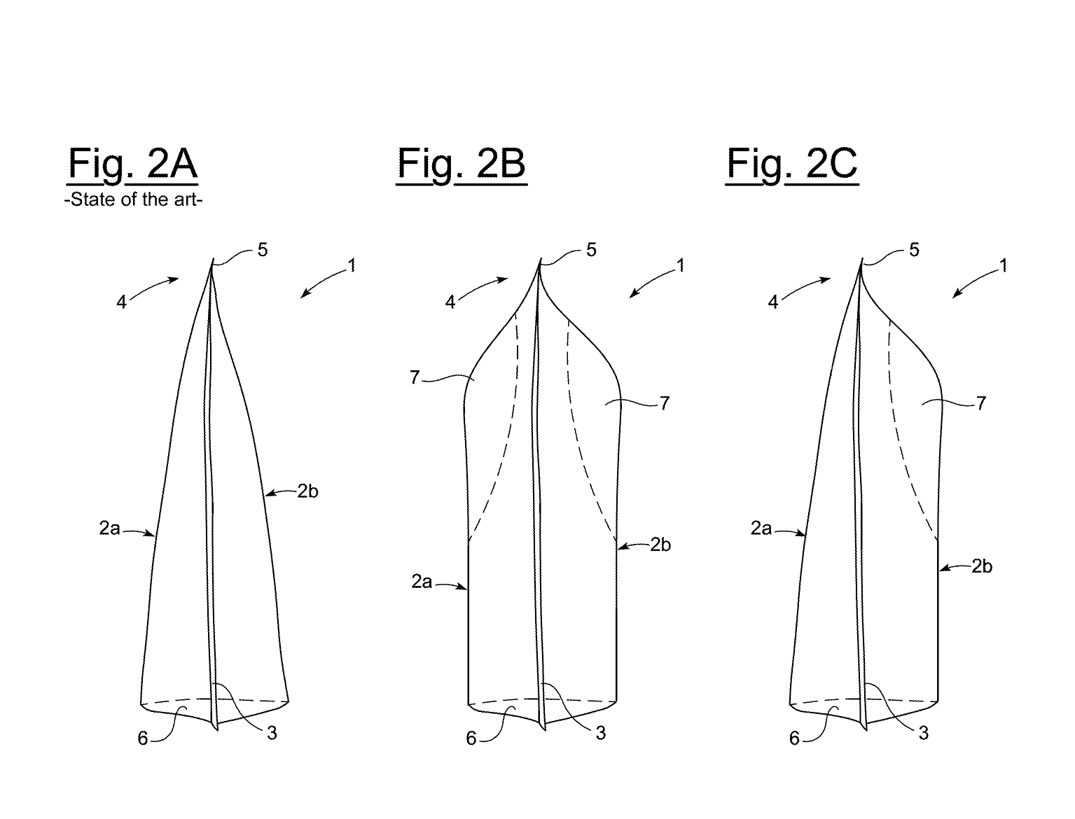

In contrast, FIG. 2A shows a stand-up film pouch according to the prior art, wherein the illustrated side view shows approximately a triangular shape. The pouch body 1 can then also be referred to as being conical to a certain extent, proceeding from the stand-up bottom 6 thereof, even though the upper pouch edge 4 is of course not pointed in width, but essentially extends over a comparable width as the stand-up bottom 6, which, however, is outwardly bulged toward the front and back and thus becomes slightly narrower in width.

With reference to FIG. 2A, it is apparent that the shown triangular shape results in a less than optimal ratio of surface area to filling volume of the pouch body 1. It is also apparent that, when several stand-up film pouches are arranged next to each other, considerable free spaces remain in the region of the upper pouch edge 4, resulting also in a comparatively large transport volume for corresponding containers.

FIG. 2B, in contrast, shows an embodiment according to the invention of the stand-up film pouch, wherein in this exemplary embodiment both front walls 2a, 2b have a material molding 7 deviating from a flat shape on an upper wall section, wherein the material moldings 7 can each be formed, for example, by a kind of thermoforming process.

The filling volume is significantly increased, particularly in the upper region of the pouch body, wherein the pouch body can have a filling volume that is increased by 5% to 25%, for example, compared to an embodiment according to FIG. 2A. As will also be described in more detail hereafter, the material molding 7 is not sharp-edged and is formed comparatively uniformly, so that the stand-up capability, the stability, and the functionality of the pouch body 1 are not significantly impaired.

FIG. 2C shows a variant of the present invention, wherein only one front wall 2b has the material molding. The opposite front wall 2a, in contrast, is made of a flat film section. This accordingly results in an increase in the filling volume, which is, however, smaller than in the embodiment according to FIG. 2B.

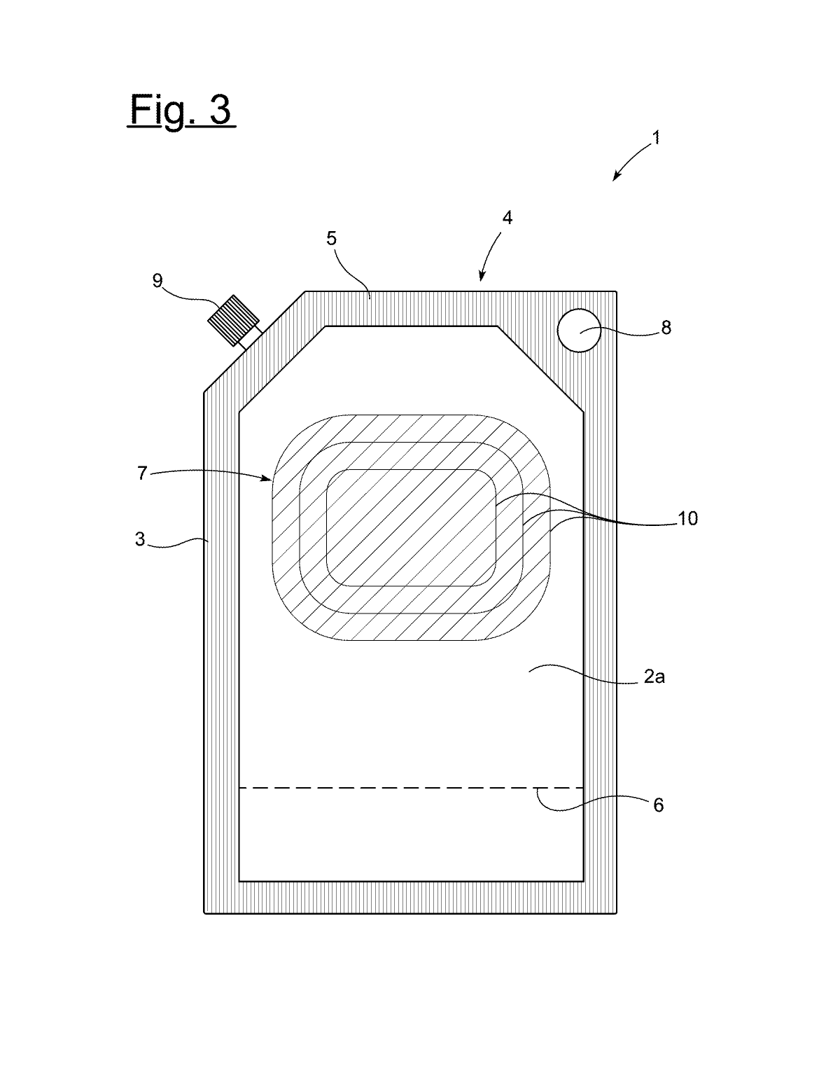

FIG. 3 shows a possible embodiment of the stand-up film pouch according to the invention in an unfilled state in a top view. Shown as a variant, the pouch body 1 can also have a finger hole 8 and a spout 9, in particular in the region of the upper pouch edge 4 thereof.

In the unfilled state, the stand-up bottom 6 is still inserted as a side gusset between the front walls 2a, 2b. In the top view, the material molding 7 is furthermore shown hatched, with contour lines 10 added for clarification.

The exemplary representation in FIG. 3 shows that the material molding 7 extends in an upper region of the pouch body over, for example, between 30% and 70% of a base area of the assigned front wall 2a, 2b. It is also apparent based on the contour lines 10 that the deformation is relatively uniform and without abrupt edges, changes in thickness, or the like.

Furthermore, it is apparent that the material molding 7 ends a distance apart from the longitudinal seal seams 3 and the cross seal seam 5 at the upper pouch edge 4, so that no further weakening of the pouch body occurs at the corresponding seal seams.

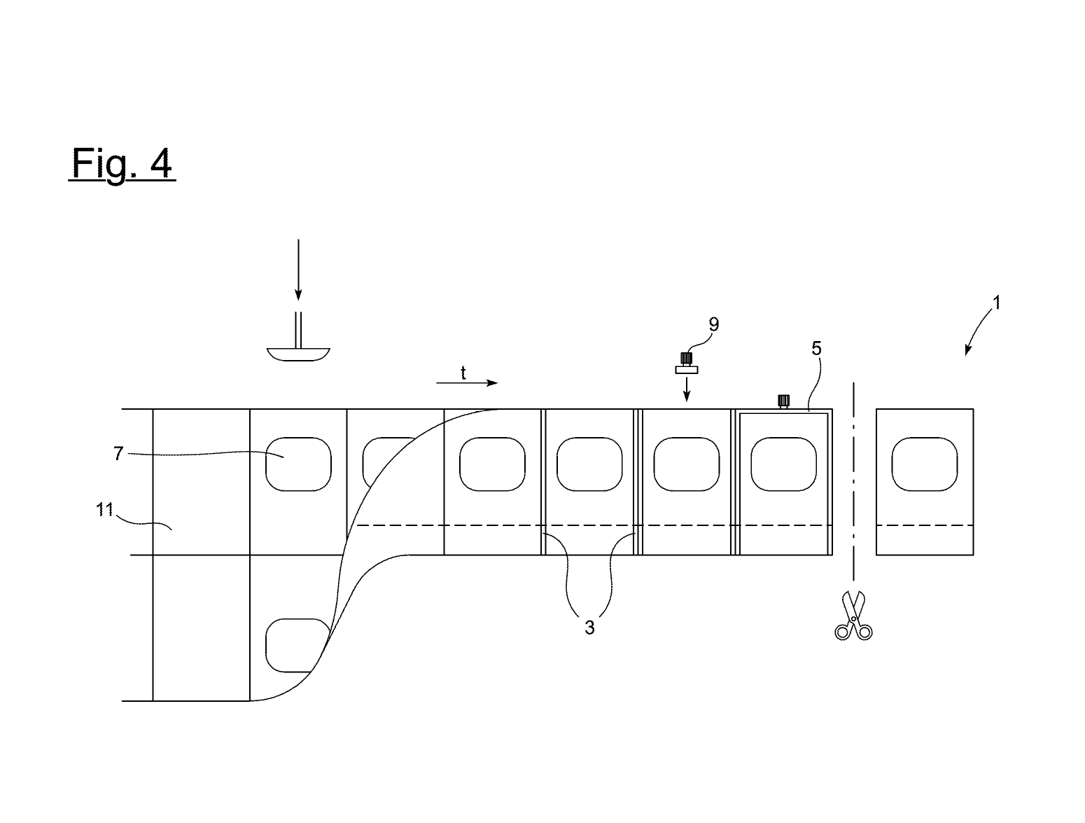

FIG. 4 schematically shows a possible production method for the stand-up film pouch, in which a film web 11 is fed. It goes without saying that the front walls 2a, 2b and the film section for forming the stand-up bottom 6 can also be provided in the form of separate strips or sections.

According to FIG. 4, the film web 11 is conveyed along a transport direction t before material moldings 7 are created on sections that subsequently form the front walls 2a, 2b.

The film web 11 is then folded onto itself, wherein two previously created material moldings 7 are arranged in alignment with each other. The longitudinal seal seams 3 are then created before a further element in the form of a spout 9 is inserted and then connected to the front walls 2a, 2b along a continuous cross seal seam 5. The individual stand-up film pouches are then separated from each other, after which they can be filled through the spout 9, which must then be sealed.

1. A stand-up film pouch comprising a pouch body, wherein the pouch body comprises two front walls that are situated opposite each other and connected to each other at the longitudinal edges thereof, and a film section that is arranged between the front walls at a pouch underside to form a stand-up bottom, wherein at least one of the front walls has a material molding deviating from a flat shape at an upper wall section.

2. The stand-up film pouch of claim 1, wherein the front walls are directly connected to each other at the longitudinal edges and at least part of an upper pouch edge.

3. The stand-up film pouch of claim 1, wherein the material molding extends over 30% to 70% of a base area of the assigned front wall.

4. The stand-up film pouch of claim 1, wherein the material molding has a bulge shape, having a deformation depth that increases from an edge to a center of the material molding.

5. The stand-up film pouch of claim 1, wherein the material molding ends a distance apart from the longitudinal edges and/or a distance apart from the upper pouch edge.

6. The stand-up film pouch of claim 1, wherein each of the two front walls has the material molding.

7. The stand-up film pouch of claim 1, wherein the pouch body is made of a single type of polyolefin, in particular polyethylene or polypropylene.

8. The stand-up film pouch of claim 1, wherein the front walls outside the material molding have a thickness between 40 µm and 200 µm.

9. The stand-up film pouch of claim 1, wherein a minimum thickness of the respective front wall in the region of the material molding is between 30 µm and 180 µm.

10. The stand-up film pouch of claim 1, wherein the pouch body comprises a carrying handle and/or a spout.

11. The stand-up film pouch of claim 1, wherein a filling volume of the pouch body is increased by 5% to 25% compared to a pouch body without material molding.

12. A method for producing a stand-up film pouch, wherein a pouch body is formed from a film web or film sections, which has two front walls that are situated opposite each other and connected to each other at the longitudinal edges thereof, and a film section that is arranged between the front walls on a pouch underside to form a stand-up bottom, wherein a material molding which deviates from a flat shape is formed on at least one of the front walls before the pouch body is formed or on both front walls after the pouch body has been formed, in particular by thermoforming.

13. The method of claim 12, wherein the film web or at least a film section is provided with a locally distorted print before the material molding is created in such a way that the creation of the material molding reduces or eliminates the distortion of the print.
